(19) United States
(12) Patent Application Publication
(10) Pub. No.: US 2009/0013254 A1
(43) Pub. Date: Jan. 8, 2009

(54) Methods and Systems for Auditory Display of Menu Items

(75) Inventors: Bruce N. Walker, Atlanta, GA (US); Pavani Yalla, Palm Harbor, FL (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Georgia Tech Research Corporation, Atlanta, GA (US)

(21) Appl. No.: 12/138,610

(22) Filed: Jun. 13, 2008

Related U.S. Application Data
(60) Provisional application No. 60/943,953, filed on Jun. 14, 2007.
(60) Provisional application No. 60/982,813, filed on Oct. 26, 2007.

(51) Int. Cl. G06F 3/16

(52) U.S. Cl. 715/727

(57) ABSTRACT

Various methods and systems are provided for auditory display of menu items. In one embodiment, a method includes detecting that a first item in an ordered listing of items is identified; and providing a first sound associated with the first item for auditory display, the first sound having a pitch corresponding to the location of the first item within the ordered listing of items.

### CROSS REFERENCE TO RELATED APPLICATIONS

This application claims priority to copending U.S. provisional applications entitled “SPEARCONS: SPEECH-BASED EARCONS FOR AUDITORY DISPLAY OF MENU ITEMS” having Ser. No. 60/943,953, filed Jun. 14, 2007, and “SPEARCONS: SPEECH-BASED EARCONS FOR AUDITORY DISPLAY OF MENU ITEMS” having Ser. No. 60/982,813, filed Oct. 26, 2007, the entirety of both are hereby incorporated by reference.

### STATEMENT REGARDING FEDERALLY SPONSORED RESEARCH OR DEVELOPMENT

This invention was made with Government support under Contract/Grant No. H133E060061, awarded by the US Department of Education. The Government has certain rights in this invention.

### BACKGROUND

Most technological devices require an exchange of information between the user and the device. Whether it involves the user's navigation through the device's system choices, selection of the device's functions, or input of information, the user needs an efficient way to interact and exchange information with the system. Although command languages offer the user flexibility and power while interacting with the system, they can also strain the user's memory. The user must memorize the numerous commands in order to efficiently communicate with the system. Generally, visual menus provide an easier solution because a person's ability to recognize is generally superior to their ability to recall.

The earliest visual menus were often just lists of options from which the user would have to select one. Visual menus can no longer be thought of as just lists of options. There are many varieties of visual menus for various applications. Although there are many different types of menus, a few fundamental characteristics of a menu may be common to most of them. A typical visual menu consists of a title (which may also be known as a stem) and one or more items. The title can be a question or a phrase acting as a categorical title. If the title is a question, the items may be possible answers to that question. If the title is a categorical designation, the items may be options that can be collectively described by the title.

Visual menus require the user to bring the item that they would like to select into focus before actually making the selection. Before making a selection, the user must visually search the available alternatives for the intended target (e.g., in a hierarchical menu, the target of a single menu frame may not be the final target, but rather an intermediate one). Additionally, users may have their own personal strategies for conducting the visual search including serial processing or a combination of both random and systematic approaches. Regardless of which visual search strategy is used, in general, repetitive exposure to a menu makes the searching process for that menu faster.

Typically a user input action, such as a key press or mouse movement, is used to move the focus from one item to another. Each item could be one of three different types: branch, leaf, and unavailable. Selection of a branch item leads to another menu (e.g., a submenu). Generally, the title of the new menu is the same as the branch item that was selected. Selection of a leaf item prompts the execution of some function or procedure. An unavailable item cannot be selected and is usually shown faded/grayed out. Its main purpose is to act as a place-holder and convey that the item could become available under other circumstances. After the user has made the necessary menu movements to arrive at the desired item, a selection of the item in focus may be made.

Feedback indicating the user focus within a visual menu can include highlighting or outlining of the item in focus. Feedback can also be given to indicate that a selection is being made of the item in focus. The highlight/outline might change color, get darker, or flash on and off while the item is being selected to provide a visual distinction between a focused item and a selected item.

### SUMMARY

Embodiments of the present disclosure are related to auditory display of menu items.

Briefly described, one embodiment, among others, comprises a method. The method comprises detecting that a first item in an ordered listing of items is identified; and providing a first sound associated with the first item for auditory display, the first sound having a pitch corresponding to the location of the first item within the ordered listing of items.

Another embodiment, among others, comprises a telephone. The telephone comprises a processor circuit having a processor and a memory; an audio display system stored in the memory and executable by the processor, the audio display system comprising: logic configured to detect that a first item in an ordered listing of items is identified; and logic configured to provide a first sound associated with the first item for auditory display through a speaker, the first sound having a pitch corresponding to the location of the first item within the ordered listing of items.

Another embodiment, among others, comprises a method. The method comprises detecting that a first item in a listing of items is identified, the first item having associated text; providing a first spearcon corresponding to the first item for auditory display, the first spearcon based upon the associated text of the first item; and providing the associated text of the first item for auditory display.

Another embodiment, among others, comprises a telephone. The telephone comprises a processor circuit having a processor and a memory; an audio display system stored in the memory and executable by the processor, the audio display system comprising: logic configured to detect that a first item in a listing of items is identified, the first item having associated text; logic configured to provide a first spearcon corresponding to the first item for auditory display through a speaker, the first spearcon based upon the associated text of the first item; and logic configured to provide the associated text of the first item for auditory display through the speaker.

Another embodiment, among others, comprises a method. The method comprises detecting the selection of a first menu; and providing a first background sound associated with the first menu for auditory display.

Another embodiment, among others, comprises a system. The system comprises means for detecting the selection of a first menu; and means for providing a first background sound associated with the first menu for auditory display.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an illustration of a mobile telephone and/or PDA, which may include an auditory display of menu items in accordance with an embodiment of the present disclosure;

FIG. 2 is a flow chart that provides one example of the operation of a system to provide auditory display of menu items on a device such as, but not limited to, the telephone and/or PDA of FIG. 1 in accordance with an embodiment of the present disclosure;

FIG. 3 is a flow chart that provides one example of the operation of a system to provide auditory display of menu items on a device such as, but not limited to, the telephone and/or PDA of FIG. 1 in accordance with an embodiment of the present disclosure;

FIGS. 4A-4B are illustrations of the use of auditory signals to convey location within a hierarchical menu according to an embodiment of the present disclosure;

FIG. 5 is a flow chart that provides one example of the operation of a system to provide auditory display of menus such as illustrated in FIGS. 4A-4B in accordance with an embodiment of the present disclosure;

FIG. 6 is a schematic block diagram of one example of a system employed to provide auditory display of menu items according to an embodiment of the present invention;

FIGS. 7-9 are graphical representations of experimental results comparing search time and accuracy of menu navigation using auditory displays of menu items in accordance with an embodiment of the present disclosure; and

FIG. 10 is a graphical representation of experimental results comparing learning rates using auditory displays of menu items in accordance with an embodiment of the present disclosure.

### DETAILED DESCRIPTION

Disclosed herein are various embodiments of methods and systems related to auditory display of menu items. Reference will now be made in detail to the description of the embodiments as illustrated in the drawings, wherein like reference numbers indicate like parts throughout the several views.

A visual interface conveys information in a primarily parallel manner. On a visual screen, the user can see several visual objects (title, items, and other contextual information) simultaneously and continuously. In contrast, an auditory interface often conveys information serially (e.g., playing successive sounds or words based on where the user focus is at any particular time). There is a tradeoff associated with conveying information serially versus in parallel. It is not uncommon for serial communication to take more time than parallel communication, while parallel communication may lead to clutter or information overload.

For visual menus, a breadth versus depth balance may be sought by reducing the amount of information presented or by presenting the information in a more serial manner (e.g., breaking up a menu into submenus and presenting them on different screens). For auditory menus, the designer may seek a balance by reducing the time it takes to convey the sound or by conveying more information in parallel (e.g., playing several sounds at the same time). Careful design of the parallel sounds approach may prevent auditory clutter. Auditory menus may be utilized in, but not limited to, telephones, personal digital assistants (PDA), computers, and other control devices which include a user interface.

The types of menus can include, but are not limited to, single, sequential linear, simultaneous, hierarchical, connected graph, event trapping, pie, pop-up, pull-down, multiple selection, and fish-eye. The breadth versus depth balance defines the way content is organized across screens in a visual menu. Available screen space may limit the amount of information that may be displayed without cluttering the screen. In contrast, design of a purely auditory menu does not rely on screen space at all. For example, visual menus in a cell phone tend to be deeper and less broad because of the small screen-size. Broader and less deep menus may be more efficient for an auditory interface by preventing users from getting lost in a deep menu structure with many levels. On the other hand, due to the serial quality of auditory menus, a menu that is too broad may cause information overload.

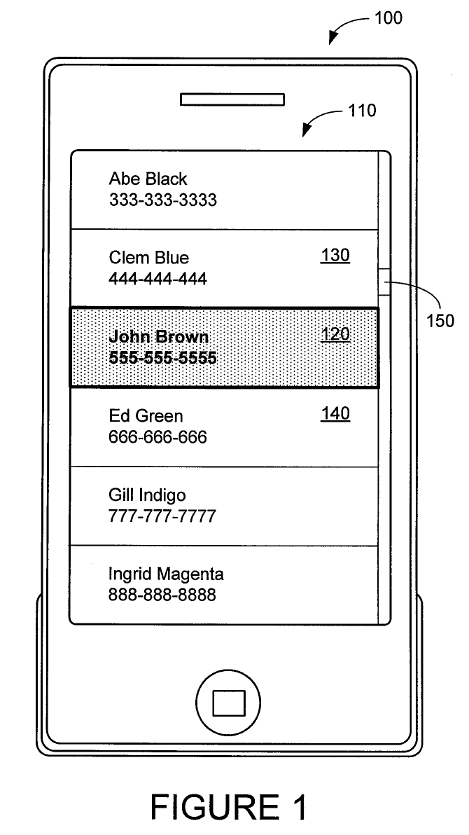

Contextual information includes menu characteristics such as, but not limited to, menu size, overall menu structure, and a user's location within the structure. Conveying contextual information is just as important for an auditory menu as it is for a visual menu. FIG. 1 is an illustration of a mobile telephone and/or PDA 100, which may include an auditory display of menu items in accordance with an embodiment of the present disclosure. In the embodiment of FIG. 1, a menu 110 including a listing of items is visually displayed on the telephone and/or PDA 100. The menu may include a listing of contacts or other options available to the user.

To access one of the contacts or options, a user may identify an item that they would like to select by bringing the contact item into focus before actually making the selection. In some embodiments, a user input action, such as a key press or mouse movement, is used to move the focus from one object to another. This is called a “pull” menu, as distinct from a “push” menu, in which the focus moves from item to item automatically (often in a loop). In other embodiments, touch screen inputs may be used to move and identify an item (e.g., place an item in focus). In the embodiment of FIG. 1, a user of the telephone and/or PDA 100 has moved the focus to item 120 labeled “John Brown”. In the exemplary embodiment of FIG. 1, the identified item in focus (i.e., item 120) is indicated by both highlighting and outlining. While not illustrated, the user may move the focus using a touch screen, thumbwheel, key, or other appropriate means. Items in a purely auditory menu may be identified or placed in focus without a visual display.

The size of a menu with audio display may be conveyed through several methods. In one embodiment, the items of a menu list may be associated with sequential numbers. When a user focuses on a listed item, the associated number is spoken. This may be followed by the total number of items in the list. For example, in the embodiment of FIG. 1, item 120 labeled “John Brown” is illustrated as the item identified by a user of the telephone and/or PDA 100. If item 120 labeled “John Brown” is the tenth contact in the listing of menu 110 (e.g., a telephonic address book) and there are a total of forty nine contacts in the listing, the telephone and/or PDA 100 may audiblize or broadcast “John Brown . . . ten of forty nine.” This information may be given for each item in the list as the user's focus changes.

In other embodiments, non-speech sounds may be used to convey the same information. Non-speech sounds are sounds that are not intelligible as speech. In one embodiment, the location of an item identified within a menu list is conveyed through the pitch of a tone. For example, consider the following sonified version of a telephone address book. As the user presses the “down” key on a telephone's keypad or touch screen to scroll through the list of contacts, the focus shifts from one contact to the next one and beeps may be produced as the focus shifts to each contact. The pitches of the beeps are mapped to the location of the contact (or item) in the menu list. For example, an item may be associated with a low pitched beep when located lower in the list and an item may be associated with a higher pitched beep when located higher in the list.

In the exemplary embodiment of FIG. 1, item 120 labeled “John Brown” may correspond to a beep with a pitch that is lower than the pitch of the beep corresponding to item 130 labeled “Clem Blue” and higher than the pitch of the beep corresponding to item 140 labeled “Ed Green”. Alternatively, the pitch may vary from low to high as the user scrolls down the menu list (e.g., a contact list). As the user scrolls through the menu items, the pitches of the beeps could give the user an idea of their location within the menu. In alternative embodiments, other sounds or tones may be used to convey location by varying the pitch. This method of using pitches to convey location may be considered an auditory scrollbar.

In some embodiments, among others, information about the size of the menu may be conveyed based upon the entire range of pitches across the menu. In one exemplary embodiment, the range of pitches can consistently span one whole octave. For example, if the menu consists of ten items, the octave would be divided into ten different pitches, which are equally spaced over the octave. If the menu list consists of fifty items, the octave would be divided into fifty different pitches. Therefore, the difference in pitch between two consecutive items in a long menu would be smaller than the difference in pitch in a short menu. This is analogous to how the thumb 150 (FIG. 1) of a visual scrollbar varies in size from smaller in a long menu to larger in a short menu.

In an alternative embodiment of an auditory scrollbar, for each contact that is identified or in focus, two short beeps are heard. In one embodiment, the pitch of the first beep indicates the location value of that particular contact, and the pitch of the second beep indicates the location for the very last contact in the list. Therefore, the second beep is always at the same pitch and acts as a reference for comparison to the first beep. If the user hears a relatively large difference in pitch between the two beeps for the first contact, he or she knows that the list is probably long. In other embodiments, other sounds, tones, or combinations may be used to convey location by varying the pitch.

As the user scrolls down the list, he or she hears that the two beeps get closer and closer together in pitch until they are the same. This informs the user that the end of the menu list has been reached. In an embodiment where the range of pitches spans an octave, the relative difference between the two beeps also indicates position within the list. A larger difference indicates that the item in focus is closer to the beginning of the menu list, while a smaller difference indicates a location further down the list.

There are many possible variations of this “two beep pitch gap” approach. For example, the reference beep may be heard before the location value beep. In alternative embodiments, the reference beep could refer to the very first contact (instead of the last). In other embodiments, the reference beep may change based upon a change in the scrolling direction. In one exemplary embodiment, as a user scrolls down the menu list, the reference beep is the beep with the pitch associated with the last item in the list. When the user changes scrolling direction by scrolling up the list, the pitch of the reference beep changes to the pitch associated with the first item in the list. In this way, the direction of movement within the menu may be indicated. In one embodiment of FIG. 1, if the user scrolls up from item 120 labeled “John Brown” by moving the focus to item 130 labeled “Clem Blue”, the reference beep has the pitch associated with the first item in the list. However, if the user scrolls down from item 120 labeled “John Brown” by moving the focus to item 140 labeled “Ed Green”, the reference beep has the pitch associated with the last item in the list.

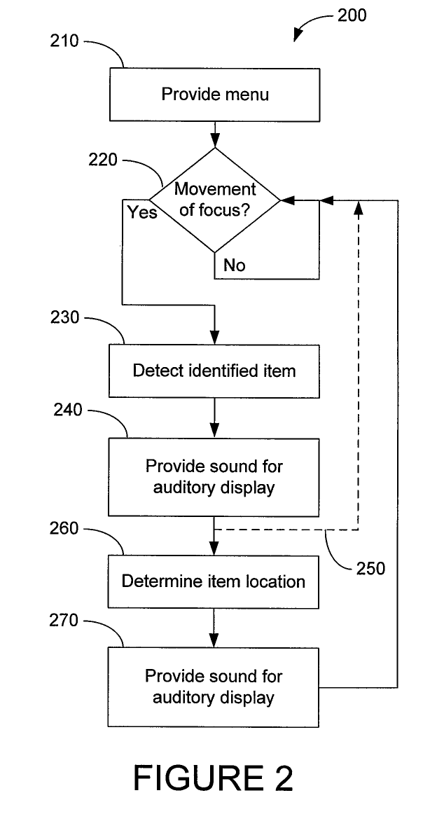

FIG. 2 is a flow chart that provides one example of the operation of a system to provide auditory display of menu items on a device such as, but not limited to, the telephone and/or PDA 100 of FIG. 1 in accordance with an embodiment of the present disclosure. To begin, a menu may be provided in block 210. In one embodiment, the menu may include an ordered listing of items. When the focus moves through the listing (block 220), the next identified item (e.g., the next item in focus) is detected in block 230. A sound corresponding to the identified item in block 230 is then provided for auditory display (e.g., broadcasting through a telephone speaker, computer speaker, headphones) in block 240. In one embodiment, the sound may be a beep or tone having a pitch corresponding to the location of the first item within the ordered listing of items. In other embodiments, the sound may be a number, auditory icon, earcon, or spearcon.

In some embodiments, only a single indication is provided as each item comes into focus. This is illustrated in the flow chart 200 by line 250, which returns to block 220 to monitor for movement to another menu item. Movement within a listing of terms may be sequential, such as scrolling through a linear list, or non-sequential, such as using shortcuts or a touch screen to move to non-sequential items.

In other embodiments, a second sound is also provided for auditory display after the first sound of block 240. In some embodiments, the second sound is always the same with a pitch corresponding to either the first or last location in the ordered listing of items. In alternative embodiments, the second sound may be based on movement of the focus. For example, if the next item detected in block 230 has a location within the ordered listing of items that is between the location of the previous identified (or in focus) item and the last location in the ordered listing of items, the sound corresponding to the last item is provided for auditory display. This is illustrated in FIG. 2 by block 260 where the item location is determined and compared to the location of the previous identified (or in focus) item. Based upon this comparison, the second sound corresponding to either the first or last location in the ordered listing of items is provided in block 270. If the identified item in block 230 is either the item in the first location or the item in the last location, the corresponding sound may be provided for auditory display a second time. The method may then return to block 220 to monitor for movement to another menu item.

In alternative embodiments, different sounds may correspond to one or more items in a menu. The pitch of the corresponding sounds may vary in pitch based upon the location of the item in the menu. The sounds can include, but are not limited to, auditory icons, earcons, spearcons, and tones.

While speech (e.g., through Text-To-Speech or TTS) may be used to convey menu content, non-speech sounds may also be utilized in auditory menus. Non-speech audio can be used to enhance a TTS menu, for example to provide extra navigational cues. Non-speech sounds may also replace the TTS altogether. Auditory icons, earcons, and spearcons are three specific types of non-speech sounds which may be used to enhance a TTS menu.

Auditory icons are representations of the noise produced by, or associated with, the thing they represent. In the case of an auditory menu, the auditory icon would sound like the menu item. Auditory icons may use a direct mapping (e.g., representing the item “dog” with the sound of a dog barking), so that learning rates may be reduced. Unfortunately, the directness of the mapping can vary considerably. For example, the sound of a typewriter could represent a menu item for “Print Document” in a fairly direct, but not exact, mapping of sound to meaning. However, there is often no real sound available to represent a menu item. For example, there is really no natural sound associated with deleting a file. Thus, in many cases a metaphorical representation would need to be used, rather than the intended direct iconic representation. The mapping may even become completely arbitrary, which requires extensive learning, and opens the door for interference by other preconceived meanings of the cue sounds. For this reason, genuine auditory icons may offer limited utility in practical auditory menu applications.

Earcons may be described as “non-verbal audio messages that are used in a computer/user interface to provide information to the user about some computer object, operation or interaction.” Earcons are musical motifs that are composed in a systematic way, such that a family of related musical sounds can be created. For example, a brief trumpet note could be played at a particular pitch. The pitch may be raised one semi-tone at a time to create a family of five distinct but related one-note earcons. The basic building blocks of earcons can be assembled into more complex sounds, with the possibility of creating a complete hierarchy of sounds having different timbres, pitches, tempos, and so on. These sounds may then be used as cues to represent a hierarchical menu structure.

For example, the top level of a menu might be represented by single tones of different timbres (e.g., a different musical instrument for each level); each timbre/instrument would represent a submenu. Then, each item within a submenu might be represented by tones of that same timbre/instrument. Different items in the submenu could be indicated by different pitches, or by different temporal patterns. Users learn what each of the cue sounds represents by associating a given sound with its menu item or menu. Users may eventually be able to use the sounds on their own for navigation through the menu structure. Earcons combined with speech may aid in increasing the efficiency and accuracy of menu navigation without increasing work load for the user. While earcons may be used to represent hierarchies by building families of sounds, they are limited by the considerable amount of training that may be required to learn the meanings of the auditory elements, the difficulty involved in adding new items to a hierarchy previously created, and their lack of portability among systems.

Spearcons are brief audio cues that may perform the same roles as earcons and auditory icons, but in a more effective manner. A spearcon is a brief sound that is produced by speeding up a spoken phrase, even to the point where the resulting sound is no longer comprehensible as a particular word (i.e., non-speech). The term is a play on the term earcon for speech-based earcon, even though spearcons are not generally musical. Spearcons are created by converting the text of a menu item (e.g., “Export File”) to speech via text-to-speech (TTS), and then speeding up the resulting audio clip (e.g., a synthetic TTS phrase) without changing pitch. The audio clip may be speed up to the point that it may no longer be comprehensible as a particular word or phrase (i.e., non-speech). In essence, each spearcon forms an acoustical fingerprint that is related to the original textual phrase by this derivation.

Spearcons may be created using linear or non-linear compression, which includes, but is not limited to, exponential or logarithmic compression. Non-linear compression, where short sounds are compressed less and longer sounds are compressed by a larger ratio, may allow the resulting spearcons that fall within a smaller range of lengths because of the additional compression of longer words or phrases. Additional reduction in length may also be accomplished by preprocessing the word or phrase before compression. This preprocessing may include, but is not limited to, shortening or removing vowel sounds and/or soft consonants. All of this may be automated. Spearcons are also naturally brief, easily produced, and are as effective in dynamic or changing menus as they are in static, fixed menus. Spearcons may provide navigational information (e.g., which menu is active) by varying, for example, gender of the speaker, pitch, or other kinds of navigational cues.

The spearcon may then be used as the cue for the menu item from which it was derived. Spearcons are unique to the specific menu item, just as with auditory icons, though the uniqueness is acoustic, and not semantic or metaphorical. At the same time, the similarities in menu item content cause the spearcons to form families of sounds. For example, the spearcons for “Save”, “Save As”, and “Save As Web Page” are all unique, including being of different lengths. However, they are acoustically similar at the beginning of the sounds, which allows them to be grouped together (even though they are not comprehensible as any particular words). Different lengths may help the listener learn the mappings, and provide a “guide to the ear” while scanning down through a menu, just as the ragged right edge of items in a visual menu aids in visual search. While non-linear compression shortens longer words or phrases more than linear compression, the relative lengths of the original words or phrases are preserved, which may provide additional information to the user.

Since the mapping between spearcons and their menu item is non-arbitrary, there is less learning required than would be the case for a purely arbitrary mapping. The menus resulting from the use of spearcons may be re-arranged, sorted, and have items inserted or deleted, without changing the mapping of the various sounds to menu items. Spearcons can be created algorithmically, so they can be created dynamically, and can represent any possible concept. Thus, spearcons may support more “intelligent”, flexible, automated, non-brittle menu structures.

The selection time in a serial auditory menu may also be reduced through the use of spearcons. Time-compression of the speech combined with the relationship to the original textual phrase may reduce the time needed to listen to the items and, therefore, reduce the selection time. In other embodiments, preempting of the sounds may be allowed. This may allow the user to move the focus from one item to another before the sound for that item is completely played. If the user could tell which item was under focus just by listening to the beginning of the sound, they could potentially scroll through all the undesired items very quickly before reaching the target item.

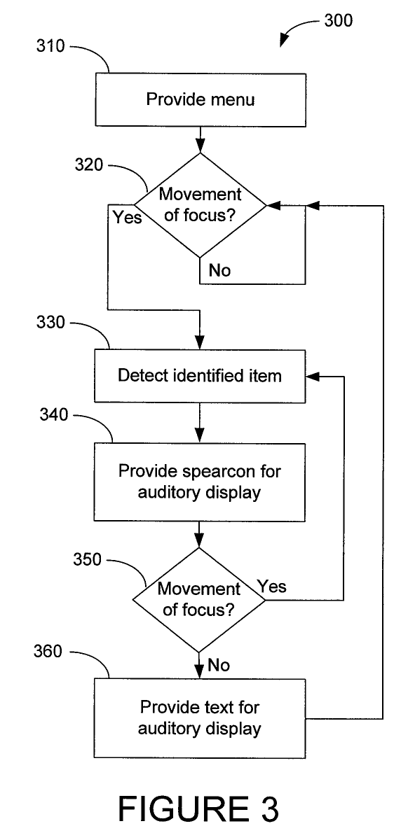

FIG. 3 is a flow chart that provides one example of the operation of a system to provide auditory display of menu items on a device such as, but not limited to, the telephone and/or PDA 100 of FIG. 1 in accordance with an embodiment of the present disclosure. A menu may be provided in block 310. In one embodiment, the menu may include an ordered listing of items. When the focus moves through the listing (block 320), the next identified (or in focus) item is detected in block 330. A spearcon corresponding to the identified (or in focus) item in block 340 is then provided for auditory display (e.g., broadcasting through a telephone speaker, computer speaker, or headphones) in block 340. The spearcon is based upon text associated with the identified item (or item in focus).

In the embodiment of FIG. 3, if the focus does not move to a new item in block 350, the text is provided for auditory display in block 360. In some embodiments, this is accomplished using TTS. The method then returns to block 320 to monitor for movement of the focus. Alternatively, if the focus does move to a new item in block 350, the new identified item is detected in block 330 and the spearcon corresponding to the new identified (or in focus) item in block 340 is provided for auditory display in block 340. The method returns to check for movement of the focus in block 350.

The way content is organized within a single menu frame of an auditory menu may also change. For example, consider the ordering of menu items. For instance, if it is logical for the items to be ordered alphabetically in a visual menu, this may not change in an auditory menu in one embodiment. However, in alternative embodiments, ordering schemes such as split menus or ordering items by frequency of use may be used. Since the menu items may be conveyed serially in an auditory menu, sorting by frequency of use may reduce the time it takes a user to make a selection. In many instances, the user would only have to listen to the first few items before making a selection. Additionally, in a visual split menu, there is usually a visual divider between the split items and regular list so the user knows that they are using a split menu. Auditory split menus may also convey this information using spatial separation.

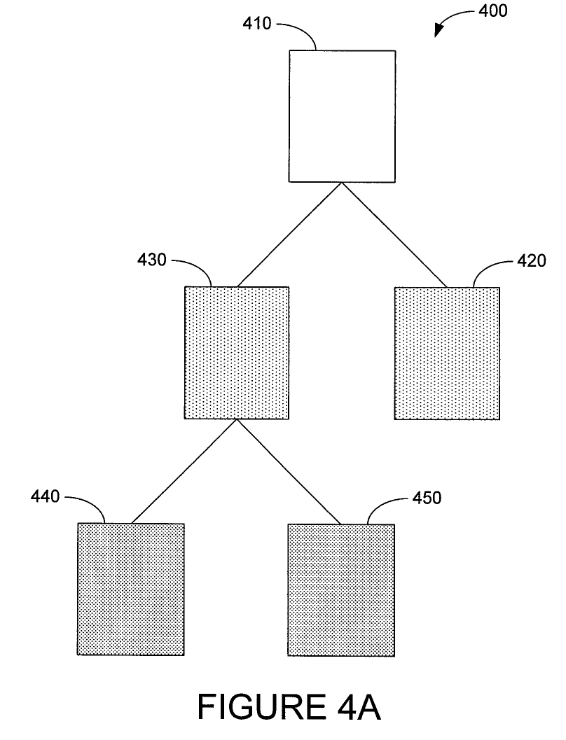

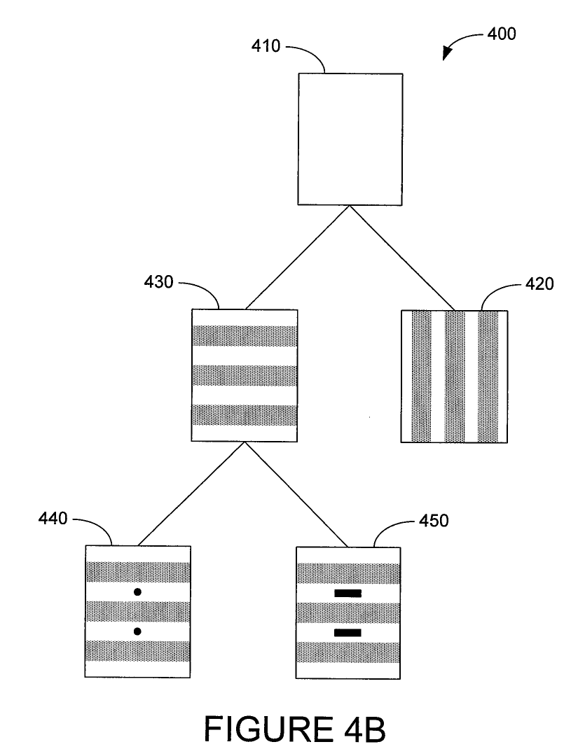

Other menus may utilize branching outputs to form a hierarchical menu consisting of multiple linear menus in a tree-like structure. In visual menus, methods such as cascading and the use of background color convey information regarding location within a hierarchical menu structure. In auditory menus, this may be accomplished through the use of background sounds to indicate location and/or depth within a hierarchical menu. At any given submenu of a hierarchical menu, a unique sound or tone may be continuously playing in the background. FIGS. 4A-4B are illustrations of the use of auditory signals to convey location within a hierarchical menu 400 according to an embodiment of the present disclosure.

In the embodiment of FIG. 4A, a background sound which is unique for each level of the hierarchical structure is used to indicate the depth of a selected menu or submenu. This method allows the user to realize that they have entered a different level by providing a background sound that corresponds to the level of the current menu. In the exemplary embodiment of FIG. 4A, a root menu 410 is provided to a user with no background sound presented. In other embodiments, a background sound may be presented with the root menu. The root menu 410 of FIG. 4A includes options for selecting submenus 420 and 430. If the user selects either submenu 420 or submenu 430, the same background sound corresponding to the first sublevel is provided to the user. In FIG. 4A, this is illustrated by submenus 420 and 430 having the same shading.

While submenu 420 is illustrated as including no submenu options, submenu 430 includes options for selecting submenus 440 and 450. If the user selects either submenu 440 or submenu 450, the same background sound corresponding to the second sublevel is provided to the user. In FIG. 4A, this is illustrated by submenus 440 and 450 both having the same shading, which is different from the shading of submenus 420 and 430. In alternative embodiments, the background may include earcons corresponding to the level of the selected submenu. All horizontally adjacent submenus could have the same background earcon. Therefore, the background earcon would tell the user how deep they are in the hierarchy, but not distinguish between different nodes at the same depth level. In other embodiments, auditory icons and/or spearcons may be utilized.

Vertical separation of the hierarchical menu 400 may be provided as illustrated in FIG. 4B. In the embodiment of FIG. 4B, each background sound corresponding to a submenu refers to intermediate menus that the user had to go through before getting to the current submenu. Thus, the background sound provides information for keeping track of all previous selections. In one embodiment of FIG. 4B, the root menu 410 is provided to a user with no background sound presented. The root menu 410 of FIG. 4B includes options for selecting submenus 420 and 430. If the user selects submenu 420, a first background sound corresponding to submenu 420 is presented, while if the user selects submenu 430, a second background sound corresponding to submenu 430 is provided to the user. In FIG. 4B, the different sounds are illustrated by submenu 420 having vertical shaded areas, while submenu 430 has horizontal shaded areas. The background sounds may include, but are not limited to, earcons, spearcons, tones, and tone sequences. In some embodiments, the same background sound is provided for submenus 420 and 430 with a different pitch corresponding to each submenu.

In the embodiment of FIG. 4B, submenu 430 includes options for selecting submenus 440 and 450. If the user selects submenu 440, a third background sound corresponding to submenu 440 is presented. As illustrated by the shading of submenu 440, the third background sound includes both the second background sound of submenu 430 and an additional sound to produce a unique sound corresponding to submenu 440. In this way, the vertical or path information is retained in the auditory display. If submenu 450 is selected, the corresponding background sound includes both the second background sound of submenu 430 and an additional sound different from that corresponding to submenu 440. In FIG. 4B, this is illustrated by submenu 440 including both the vertical shaded areas of submenu 420 and the additional sound illustrated by the added spots. Similarly, submenu 450 includes the vertical shaded areas of submenu 420 but a different additional sound is included, and represented by the added rectangles.

In other embodiments, earcons may be used indicate the submenu. In one exemplary embodiment, as the user makes another selection, a new submenu opens with a new earcon playing in the background. This earcon sounds the same as the one before it, but it plays the additional sound of the new submenu. In alternative embodiments, spearcons may be used to indicate the submenu. Spearcons may be used to communicate locations within the hierarchical menu structure by using phrases that include both the current menu title and all intermediate titles. For example, the menus may be assigned titles with the title of each submenu including the titles of all intermediate menus. The spearcon would then include the sounds of all intermediate menus, and thus provide an indication of the path from the root menu 410.

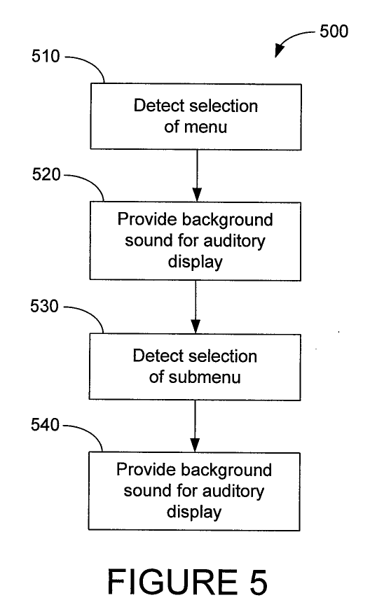

FIG. 5 is a flow chart that provides one example of the operation of a system to provide auditory display of menus such as illustrated in FIGS. 4A-4B in accordance with an embodiment of the present disclosure. When the selection of a menu is detected in block 510, a background sound associated with the selected menu is provided for auditory display in block 520. Background sounds that may be used include, but are not limited to, spearcons, earcons, and/or one or more tones. In one embodiment, the background sound is a spearcon corresponding to the title of the selected menu of block 510. In other embodiments, the background sound may correspond to the depth of the selected menu within a hierarchical menu structure such as, but not limited to, the structure 400 illustrated in FIGS. 4A-4B.

In the exemplary embodiment of FIG. 5, the selection of a submenu of the selected menu is detected in block 530. A background sound associated with the selected menu is then provided for auditory display in block 540. In one embodiment, the background sound is a spearcon corresponding to the title of the selected menu of block 510 and the title of the selected menu of block 530. Alternative embodiments may have a background sound including the background sound of the selected menu of block 510 and other sounds associated with the selected submenu of block 530.

Besides tracking previous selections, future outcomes of auditory menus may also be indicated just as it is in a visual menu by indicating what the outcome of a selection will be before the selection is made. In one exemplary embodiment, as the user moves the focus of the menu from item to item, a sound could be played to indicate what type of item (branch, procedure, or unavailable) is under focus. One example of sonifying this information is the use of different types of text-to-speech conversion. If the menu items are being spoken using text-to-speech, perhaps a male voice could indicate a procedure; a female voice could indicate a branch, and a whispered voice (either male or female) could indicate an unavailable item. As a result, without having selected anything, the user may predict the result if the focus item is selected. In other embodiments, voice gender may be used to indicate if an item is available for selection or is unavailable.

Non-speech sounds can help give the user feedback during interaction with a menu. Sounds may be different depending on the function. For example, in some embodiments, the sound for a focus movement between items may be a short beep, while the sound for a selection may be a short melody consisting of three notes.

More specific feedback about focus such as, but not limited to, information about what type of item is under focus can be conveyed using distinct sounds for each type. In addition, each different type of movement may sound different. For example, movement from a menu to an item may sound different from movement between items. In other embodiments, a unique sound might be played when wrapping occurs, alerting the user that the last menu item has been reached while scrolling. For example, when the focus jumps to the first menu item after scrolling down past the last menu item (or when the focus wraps from the first item to the last item), the unique sound may be played. Similarly, even more specific feedback could be given about the type of selection made. For example, selection of a procedure item may sound different than selection of a branch item.

Additionally, auditory feedback (either speech or non-speech) may be provided when a focused item has a shortcut associated with it. Shortcuts can allow single-step movements within a hierarchal structure. In a visual menu examples for shortcuts are displayed in text (e.g., “CTRL+N”) next to the item to indicate that the user may press the “CTRL” and “N” keys to shortcut directly to that item. In an auditory menu, text-to-speech (TTS) may be used to say the shortcut when the item comes under focus.

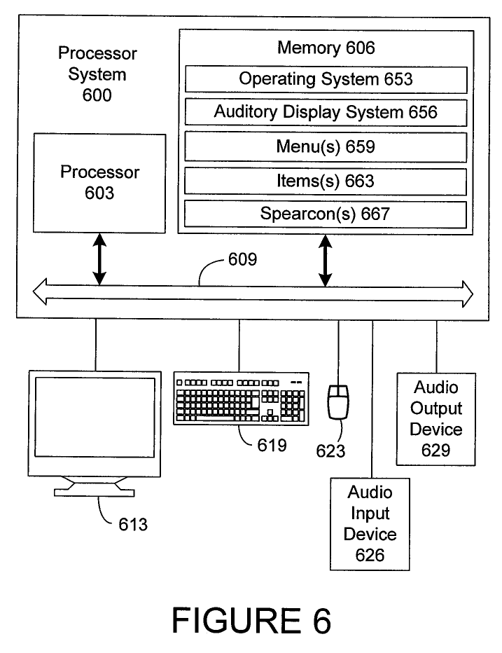

Referring next to FIG. 6, shown is one example of a system that performs various functions using auditory display of menu items according to the various embodiments as set forth above. As shown, a processor system 600 is provided that includes a processor 603 and a memory 606, both of which are coupled to a local interface 609. The local interface 609 may be, for example, a data bus with an accompanying control/address bus as can be appreciated by those with ordinary skill in the art. The processor system 600 may comprise, for example, a computer system such as a server, desktop computer, laptop, personal digital assistant, telephone, or other system with like capability. In other embodiments, the auditory display may be provided through a telephone-based interface used for services such as, but not limited to, automated banking transactions and airline ticket scheduling.

Coupled to the processor system 600 are various peripheral devices such as, for example, a display device 613, a keyboard 619, and a mouse 623. In addition, other peripheral devices that allow for the capture and display of various audio sounds may be coupled to the processor system 600 such as, for example, an audio input device 626, or an audio output device 629. The audio input device 626 may comprise, for example, a digital recorder, microphone, or other such device that captures audio sounds as described above. Also, the audio output device 629 may comprise, for example, a speaker system, headphones, or other audio output device 629 as can be appreciated.

Stored in the memory 606 and executed by the processor 603 are various components that provide various functionality according to the various embodiments of the present disclosure. In the example embodiment shown, stored in the memory 606 is an operating system 653 and an auditory display system 656. In addition, stored in the memory 606 are various menus 659, items 663, and spearcons 667. The menus 659 may be associated with a title and shortcuts, which may be stored in the memory 606. The items 663 may be associated with text and shortcuts, which may be stored in the memory 606. Other information that may be stored in memory 606 includes, but is not limited to, earcons, tones, and pitch assignments. The menus 659, items 663, and spearcons 667 may be stored in a database to be accessed by the other systems as needed. The menus 659 may include lists of items or other menus as can be appreciated. The menus 659 may comprise, for example, an ordered listing of items such as, but not limited to, contacts and corresponding personal data, etc.

The auditory display system 656 is executed by the processor 603 in order to provide auditory display as described above. A number of software components are stored in the memory 606 and are executable by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, or source code that may be expressed in proper format such as object code that is capable of being loaded into a random access portion of the memory 606 and executed by the processor 603, etc. An executable program may be stored in any portion or component of the memory 606 including, for example, random access memory, read-only memory, a hard drive, compact disk (CD), floppy disk, or other memory components.

The memory 606 is defined herein as both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

The processor 603 may represent multiple processors and the memory 606 may represent multiple memories that operate in parallel. In such a case, the local interface 609 may be an appropriate network that facilitates communication between any two of the multiple processors, between any processor and any one of the memories, or between any two of the memories etc. The processor 603 may be of electrical, optical, or molecular construction, or of some other construction as can be appreciated by those with ordinary skill in the art.

The operating system 653 is executed to control the allocation and usage of hardware resources such as the memory, processing time and peripheral devices in the processor system 600. In this manner, the operating system 653 serves as the foundation on which applications depend as is generally known by those with ordinary skill in the art.

The flow charts of FIGS. 2, 3, and 5 show the architecture, functionality, and operation of an implementation of the auditory display system 656. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although flow charts of FIGS. 2, 3, and 5 show a specific order of execution, it is understood that the order of execution may differ from that which is depicted. For example, the order of execution of two or more blocks may be scrambled relative to the order shown. Also, two or more blocks shown in succession in FIGS. 2, 3, and 5 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, where the auditory display system 656 may comprise software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the face recognition system 656 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Experimental Validation

A comparison of search time and accuracy of menu navigation was performed in two experiments using four types of auditory representations: speech only; hierarchical earcons; auditory icons; and spearcons. Spearcons were created by speeding up a spoken phrase until it was not recognized as speech (i.e., became non-speech). Using a within-subjects design, participants searched a 5×5 menu for target items using each type of audio cue. A third experiment examined the efficiency of learning a menu using earcons and spearcons.

Experiments 1 and 2 were nearly identical, with the exception of small differences in the stimuli. The near replication of Experiment 1 in Experiment 2 was important to study the stability of the results, as well as to allow for a more precise analysis of user interaction than was possible from the stimuli in Experiment 1. The following description of the experimental methods applies to both experiments, with differences between the two studies noted.

Experiment 1 involved nine participants who reported normal or corrected-to-normal hearing and vision. Experiment 2 had eleven different participants who also reported normal or corrected-to-normal hearing and vision. The apparatus was the same for both experiments. A software program written in E-Prime (Psychological Software Tools), running on a Dell Dimension 4300S PC with Windows XP, controlled the experiment, including randomization, response collection, and data recording. Participants sat in a sound-attenuated testing room, and wore Sony MDR-7506 headphones, adjusted for fit and comfort.

The menu structure chosen for both experiments was the same and is presented in Table 1. When developing the menu, it was important not to bias the study against any of the audio cue methods. For that reason, the menu includes only items for which reasonable auditory icons could be produced. This precluded a computer-like menu (e.g., File, Edit, View, etc.), since auditory icons cannot be reliably created for items such as “Select Table”. A computer menu was also avoided because that would necessarily be closely tied to a particular kind of interface (e.g., a desktop GUI or a mobile phone), which would result in confusion relating to previously learned menu orders. This is particularly important in the present study, where it was necessary to be able to re-order the menus and menu items without a participant's prior learning causing differential carryover effects. That is, it was important to assess the effectiveness of the sound cues themselves, and not the participant's familiarity with a particular menu hierarchy.

TABLE 1
Menu structure used in Experiments 1 and 2.

| Animals | Nature | Objects | Instruments | People Sounds |
|---|---|---|---|---|
| Bird | Wind | Camera | Flute | Sneeze |
| Dog | Ocean | Typewriter | Trumpet | Cough |
| Horse | Lightning | Phone | Piano | Laughing |
| Elephant | Rain | Car | Marimba | Snoring |
| Cow | Fire | Siren | Violin | Clapping |

TTS. All of the menu item text labels were converted to speech using Cepstral Text-to-Speech (TTS) (Cepstral Corp.), except for the word “camera”, which was produced using AT&T's Text to Speech demo (AT&T Research Labs). This exception was made because the Cepstral version of that word was rated as unacceptable during pilot testing. The speech phrases lasted on average 0.57 seconds (within a range of 0.29-0.98 second).

EARCON. For each menu item, hierarchical earcons were created using Apple GarageBand MIDI-based software. On the top level of the menus, the earcons included a continuous tone with varying timbre (instrument), including a pop organ, church bells, and a grand piano; these instruments are built into GarageBand. Each item within a menu used the same continuous tone as its parent. Items within a menu were distinguished by adding different percussion sounds, such as bongo drums or a cymbal crash (also from GarageBand). The earcons lasted on average 1.26 seconds (within a range of 0.31-1.67 seconds).

AUDITORY ICON. Sounds were identified from sound effect libraries and online resources. The sounds were as directly representative of the menu item as possible. For example, the click of a camera shutter represented “camera” and the neigh of a horse represented “horse”. The sounds were manipulated by hand to be brief, while still recognizable. Pilot testing ensured that all of the sounds were identifiable as the intended item. The auditory icons averaged 1.37 seconds (within a range of 0.47-2.73 seconds). Note that for the auditory icon and spearcon conditions, the category titles (e.g., “Animals”) were not assigned audio cues.

SPEARCON. The TTS phrases were sped up using a pitch-constant time compression to be about 40-50% the length of the original speech sounds. In this study, the spearcons were tweaked by the sound designer to ensure that they were generally not recognizable as speech sounds (although this is not strictly necessary). Thus, spearcons are not simply “fast talking” menu items; they are distinct and unique sounds, albeit acoustically related to the original speech item. The spearcon is analogous to a fingerprint (i.e., a unique identifier that is only part of the information contained in the original). Spearcons averaged 0.28 seconds (within a range of 0.14-0.46 second).

All of the sounds were converted to WAV files (22.1 kHz, 8 bit), for playback through the E-Prime experiment control program. For the earcon, auditory icon, and spearcon listening conditions, where the auditory cue was played before the TTS phrase, the audio cue and TTS segment were added together into a single file for ease of manipulation by E-Prime. For example, one file contained the auditory icon for sneeze, plus the TTS phrase “sneeze”, separated by a brief silence. For the “speech only” condition, the TTS phrase was played without any auditory cue in advance. The overall sound files averaged 1.66 seconds (within a range of 0.57-3.56 seconds).

In Experiment 1, the duration of the silence (or pause) between the cue and the TTS was approximately 250 milliseconds. Variations in the silence duration made some advanced analyses difficult, so in Experiment 2 the duration of the silence was identical for all stimuli, exactly 250 milliseconds. This slight but important change was made so that it could be accurately determined if participants were responding after only hearing the audio cue or were also listening to the TTS segment before making their response.

The task, which was identical in both studies, was to find specific menu items within the menu hierarchy. On each trial, a target was displayed on the screen, such as, “Find Dog in the Animals menu.” This text appeared on the screen until a target was selected, in order to avoid any effects of a participant's memory for the target item. The menus did not have any visual representation, only audio was provided as described above.

The “W”, “A”, “S”, and “D” keys on the keyboard were used to navigate the menus (e.g., “W” to go up, “A” to go left), and the “J” key was used to select a menu item. When the user moved onto a menu item, the auditory representation (e.g., an earcon followed by the TTS phrase) began to play. Each sound was interruptible such that a participant could navigate to the next menu item as soon as she recognized that the current one was not the target.

Menus “wrapped,” so that navigating “down” a menu from the bottom item would take a participant to the top item in that menu. Moving left or right from a menu tide or menu item took the participant to the top of the adjacent menu, as is typical in software menu structures. Once a participant selected an item, visual feedback on the screen indicated whether the selection was correct.

Participants were instructed to find the target as quickly as possible while still being accurate. This would be optimized by navigating based on the audio cues whenever possible (i.e., not waiting for the TTS phrase if it was not required). Participants were also encouraged to avoid passing by the correct item and going back to it. These two instructions were designed to move the listener through the menu as efficiently as possible, pausing only long enough on a menu to determine if it was the target for that trial. On each trial the dependent variables of total time to target and accuracy (correct or incorrect) were recorded. Selecting top-level menu names was possible, but such a selection was considered incorrect even if the selected menu contained the target item.

After each trial in the block, the menus were reordered randomly, and the items within each menu were rearranged randomly, to avoid simple memorization of the location of the menus and items. This was to ensure that listeners were using the sounds to navigate rather than memorizing the menus. This would be typical for new users of a system, or for systems that dynamically rearrange items. The audio cue associated with a given menu item moved with the menu item when it was rearranged. Participants completed 25 trials in a block, locating each menu item once. Each block was repeated twice more for a total of three blocks of the same type of audio cues in a set of blocks.

There were four listening conditions: speech only; earcons+speech; auditory icons+speech; and spearcons+speech. Each person performed the task with each type of auditory stimuli for one complete set. This resulted in a total of 4 sets (i.e., 12 blocks, or 300 trials) for each participant. The order of sets in this within-subjects design was counterbalanced using a Latin square.

At the beginning of each set in both experiments, participants were taught the meaning of each audio cue that would be used in that condition. During this training period, the speech version of the menu name or item was played once, followed by the matching audio cue, followed by the speech version again. These were grouped by menu so that, for example, all animal items were played immediately following the animal menu name. In the speech condition, each menu name or item was simply played twice in a row.

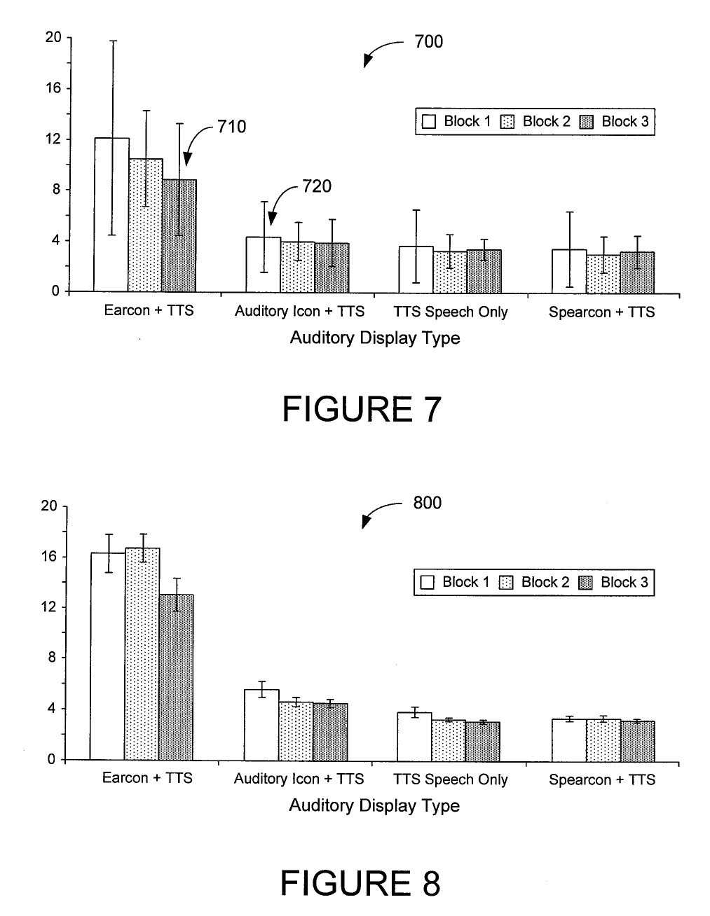

FIGS. 7-9 are graphical representations of experimental results comparing search time and accuracy of menu navigation using auditory displays of menu items in accordance with an embodiment of the present disclosure. The plots 700 of FIG. 7 present the mean time to target (in seconds) for each audio cue type, split out by the three blocks in each condition for Experiment 1. Table 2 summarizes overall mean time to target and mean accuracy results for each type of audio cue for Experiment 1, collapsing the results across blocks for simplicity. Results are sorted by increasing time to target and decreasing accuracy. Spearcons were both faster and more accurate than auditory icons and hierarchical earcons.

TABLE 2
Overall mean results for Experiment 1.

| | Mean Time to Target | Mean Accuracy |
|---|---|---|
| Type of audio cue | (SD) sec. | (SD) % |
| Spearcon + | 3.28 (.52) | 98.1 (1.5) |
| TTS phrase | | |
| TTS phrase only | 3.49 (.49) | 97.6 (2.0) |
| Auditory icon + | 4.12 (.59) | 94.7 (3.5) |
| TTS phrase | | |
| Earcon + | 10.52 (11.87) | 94.2 (5.4) |
| TTS phrase | | |

Considering both time to target and accuracy together, a multivariate analysis of variance (MANOVA) revealed that there was a significant difference between auditory cue types, F(3, 6)=40.20, p=0.006, Wilks' Lambda=0.012, and between trial blocks. F(5, 4)=12.92, p=0.008, Wilks' Lambda=0.088. Univariate tests revealed that time to target (measured in seconds) was significantly different between conditions, F(3, 24)=177.14, p<0.001. Pairwise comparisons showed that hierarchical earcons were the slowest auditory cue (p<0.001) followed by auditory icons. Spearcons were faster than the other two cue types (p=0.014). While spearcons were numerically faster than speech-only (3.28 sec. vs. 3.49 sec., respectively), this difference did not reach statistical significance (p=0.32) in Experiment 1. Accuracy was significantly different between conditions, F(3, 24)=3.73, p=0.025, with the same pattern of results (see Table 2) supported statistically.

The practice effect that is evident in the plots 700 of FIG. 7 is statistically reliable, such that participants generally got faster across the blocks in a condition, F(2, 24)=19.17, p<0.001. There was no change in accuracy across blocks, F(2, 24)=0.14, p=0.87, indicating a pure speedup, with no speed-accuracy tradeoff. The fastest earcon block 710 (Block 3) was still much slower than the slowest auditory icon block 720 (Block 1; p=0.001). Anecdotally, a couple of participants noted that using the hierarchical earcons was particularly difficult, even after completing the training and experimental trials.

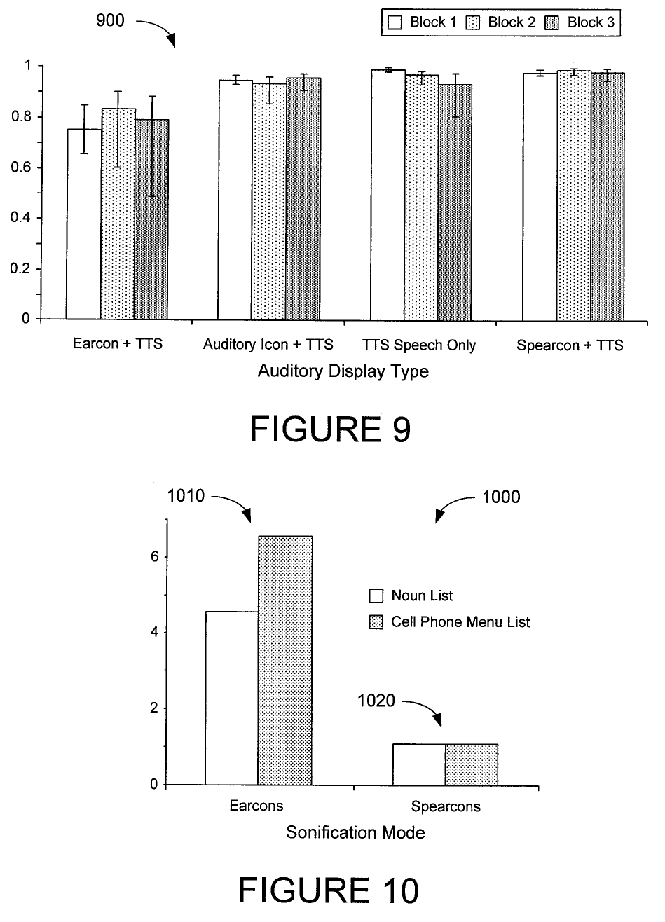

The plots 800 of FIG. 8 present the mean time to target (in seconds) for each audio cue type, split out by block for each condition in Experiment 2. The plots 900 of FIG. 9 present the mean accuracy (in %) for each audio cue type, split out by block for each condition in Experiment 2. A MANOVA showed a significant difference between auditory cue types, F(6, 5)=40.04, p<0.001, Wilks' Lambda=0.020, and between trial blocks, F(4, 7)=13.61, p=0.002, Wilks' Lambda=0.114.

As in the evaluation of Experiment 1. univariate tests showed that time to target was significantly different between conditions, F(3, 30)=95.68, p<0.001. Pairwise comparisons revealed that all the auditory cues differed significantly from each other in time to target except for spearcons and speech. Hierarchical earcons were significantly slower than auditory icons (p<0.001), speech (p<0.001), and spearcons (p<0.001). Auditory icons were significantly slower than speech (p=0.001) and spearcons (p=0.008). Accuracy between the auditory cues was also significantly different in the second study, F(3, 30)=5.22, p=0.04. Pairwise comparisons showed auditory icons to be significantly less accurate than speech (p=0.046) and spearcons (p=0.041). Similarly, hierarchical earcons were significantly less accurate than speech (p=0.0404) and spearcons (p=0.038). There was no significant difference in accuracy between hierarchical earcons or auditory icons or between speech and spearcons.

The refined stimuli in Experiment 2 allowed a more detailed analysis of whether participants made their judgments based on listening to just the prepended sound, or whether they also listened to the TTS phrase. Thus, Table 3 shows the mean percentage of times participants listened to the TTS speech for each auditory cue along with the corresponding standard errors of the mean. Results are sorted by increasing percentage of times listening to speech. Speech was listened to significantly less often when using spearcons than when using auditory icons or hierarchical earcons.

TABLE 3
Percentage of times TTS was listened to during Experiment 2.

| Type of audio cue | Mean (%) | Std Error (%) |
|---|---|---|
| Spearcon | 0.11 | 0.06 |
| Auditory icon | 0.64 | 0.20 |
| Earcon | 49.68 | 4.15 |

An analysis of variance (ANOVA) conducted on this measure showed a significant difference between auditory cue types, F(2, 20)=144.654, p<0.001. A pairwise comparison revealed that participants listened to speech when using hierarchical earcons significantly more than when using auditory icons (p<0.001) or spearcons (p<0.001), and they listened to speech significantly more when using auditory icons compared to spearcons (p=0.032). It is important to note that the data reflects every auditory cue of a given type the participants listened to (i.e., when performing a single trial during a block using auditory icons a participant would listen to multiple icons per trial while traversing the menu), and not just a measure per trial. The detailed analysis in Experiment 2 clearly shows that participants listened to speech almost half the time they were using earcons, while doing so less than 1% of the time when using auditory icons and spearcons. This demonstrates that performance is not dependent only on the length of the auditory cue, since auditory icons in this study were longer, on average, than earcons while still producing considerably better performance.

In the two experiments reported here, both earcons and auditory icons resulted in slower and less accurate performance than the speech-only condition. This would argue against their usage in a speech-based menu system, at least as far as search performance is concerned. This may not be surprising, since the addition of a 1-2 second long sound before each menu item would seem likely to slow down the user. This is particularly true with the earcons, since their hierarchical structure requires a user to listen to most or all of the tune before the exact mapping can be determined. On the other hand, the use of spearcons led to performance that was actually numerically faster and more accurate than speech alone, despite the additional prepended sound. Spearcons were also clearly faster and more accurate than either earcons or auditory icons.

While the performance gains are important on their own, the use of spearcons should also lead to auditory menu structures that are more flexible. Spearcon-enhanced menus may be resorted, and may have items added or deleted dynamically, without disrupting the mappings between sounds and menu items that users will have begun to learn. This supports advanced menu techniques such as bubbling the most frequently chosen item, or the item most likely to be chosen in a given context, to the top of a menu. Spearcons may also allow interfaces to evolve such that new functionality may be added without having to extend the audio design, which may increase the life of the product without changing the interface paradigm.

Experiment 3 examined the efficiency of learning using between earcons and spearcons. To evaluate the efficiency of learning between earcons and spearcons, participants were asked to learn sound/work pair associations for two different types of lists: a noun list and a cell phone list.

The noun list included the 30 words used in Experiments 1 and 2. This list included five categories of words, as shown in Table 4, and included a range of items for which natural (auditory icon) sound cues could be created. The words were in a menu structure, with the first word in a column representing the category title for the list of member words shown in that column. This list was used to study performance with brief, single-word menu items that were related within a menu (e.g., all animals), but not necessarily across menus. The identical words were used in an effort to replicate the previous findings of Experiments 1 and 2.

TABLE 4
Menu structure (noun) used in Experiment 3.

| Animals | People Sounds | Objects | Nature | Instruments |
|---|---|---|---|---|
| Bird | Snoring | Car | Ocean | Piano |
| Horse | Sneeze | Typewriter | Thunder | Flute |
| Dog | Clapping | Camera | Rain | Trumpet |
| Cow | Laughing | Phone | Wind | Marimba |
| Elephant | Cough | Siren | Fire | Violin |

The cell phone list, displayed in Table 5, included words that were taken from menus found in the interface for the Nokia N91 mobile phone. This list included the menu category in the first position in each column, followed by menu items that were found included in those categories. This list was used to begin to study performance in actual menu structures found in technology. As can be seen in Table 5, these words and phrases tended to be relatively longer and more technical in context. As discussed previously, most of these items do not have natural sounds associated with them, so auditory icons are not a feasible cue type.

TABLE 5
Menu structure (cell phone) used in Experiment 3.

| Text | | | | |
|---|---|---|---|---|
| Message | Messaging | Image Settings | Settings | Calendar |
| Add | New Message | Image Quality | Multimedia | Open |
| Recipient | | | Message | |
| Insert | Inbox | Show Captured | Email | Month View |
| | | Image | | |
| Sending | Mailbox | Image | Service | To Do View |
| Options | | Resolution | Message | |
| Message | My Folders | Default Image | Cell | Go To Date |
| Details | | Name | Broadcast | |
| Help | Drafts | Memory In Use | Other | New Entry |

The auditory stimuli included earcon or spearcon cues and TTS phrases, generated from the two word lists in Tables 4 and 5. During training, when listeners were learning the pairings of cues to TTS phrases, the TTS was followed by the cue sound. All TTS phrases of the word lists were created specifically for this experiment using the AT&T Labs, Inc. Text-To-Speech (TTS) Demo program. Each word or text phrase was submitted separately to the TTS demo program via an online form, and the resulting WAV file was saved for incorporation into Experiment 3.

EARCON. To make an effort to replicate the previous findings of Experiments 1 and 2, the original 30 earcons from Experiments 1 and 2 were used again as cues for the noun list of Table 4. For the cell phone list of Table 5, 30 new hierarchical earcon cues were created using Audacity software. Each menu (i.e., column in Table 5) was represented with sounds of a particular timbre. Within each menu category (column), each earcon started with a continuous tone of a unique timbre, followed by a percussive element that represented each item (row) in that category. In other words, the top item in each column in the menu structure was represented by the unique tone representing that column alone, and each of that column's subsequent row earcons included that same tone, followed by a unique percussive element that was the same for every item in that row. Earcons used in the noun list were an average of 1.26 seconds in length, and those used in the cell phone list were on average 1.77 seconds long.

SPEARCON. The spearcons in this study were created by compressing the TTS phrases that were generated from the word lists. In Experiments 1 and 2, TTS items were compressed linearly by approximately 40-50%, while maintaining the original pitch. That is, each spearcon was basically half the length of the original TTS phrase. While it is a simple algorithm, experience has shown that this approach can result in very short (single word) phrases being cut down too much (e.g., making the word into clicks), while longer phrases can remain too long. Thus, in Experiment 3, TTS phrases were compressed logarithmically, while maintaining constant pitch, such that the longer words and phrases were compressed to a relatively greater extent than those of shorter words and phrases. Logarithmic compression was accomplished by running all text-to-speech files through a MATLAB algorithm. This type of compression also decreased the amount of variation in the length of the average spearcon, because the length of the file is inversely proportional to the amount of compression applied to the file. Spearcons used in the noun list were an average of 0.28 seconds in length and those used in the cell phone list were on average 0.34 seconds long.

Experiment 3 included 24 participants (9 male, 15 female) ranging in age from 17 to 27 years (with a mean=19.9 years). All reported normal or corrected to normal hearing and vision. Participants were also native English speakers. Five of these participants, plus an additional six participants also participated in a brief follow-up study of spearcon comprehension. The age range and gender composition of these additional six participants is included in those mentioned above. Finally, three additional participants attempted the primary experiment but were unable to complete the task within the two hour maximum time limit. Data from these individuals was not included in the demographic information above or in any of the analyses that follows. Participants were tested with a computer program written with Macromedia Director to run on a Windows XP platform listening through Sennheiser HD 202 headphones. Participants were given the opportunity at the beginning of the experiment to adjust volume for personal comfort.

The participants were trained on the entire list of 30 words in a particular list type condition by presenting each TTS phrase just before its associated cute sound (earcon or spearcon). During the training phase, the TTS words were presented in menu order (top to bottom, left to right). After listening to all 30 TTS+cue pairs, participants were tested on their knowledge of the words that were presented. Each auditory cue was presented in random order, and, after each, a screen was presented displaying all of the words that were paired with sounds during the training in the grids illustrated in Tables 4 and 5. The participant was instructed to click the menu item that corresponded to the cue sound that was just played to them.

Feedback was provided indicating a correct or incorrect answer on each trial. If the answer was incorrect, the participant was played time correct TTS+cue pair to reinforce learning. The number of correct/incorrect answers was recorded. When all 30 words had been tested, if any responses were incorrect, the participant was “retrained” on all 30 words, and retested. This process continued until the participant received a perfect score on the test for that list. Next, the participant was presented with the same training process, but for the other list type. The procedure for the second list type was the same as for the first. The order of list presentation to the participant was counterbalanced.

After the testing process was complete, participants completed a demographic questionnaire about age, ethnicity, and musical experience. They also completed a separate questionnaire pertaining to their experience with the experiment, such as how long it took them to recognize the sound patterns and how difficult they considered the task to be on a six point Likert scale.

A follow-up Spearcon analysis study was also performed. Spearcons are always made from speech sounds. Most spearcons are heard by listeners to be non-speech squeaks and chirps. However, some spearcons are heard by some listeners as very fast words. To this end, an additional exploratory study was completed in conjunction with Experiment 3. After completing the main experiment, five participants assigned to the spearcon condition were also asked to complete a recall test of the spearcons they had just learned in Experiment 3. For this, a program in Macromedia Director played each of the 60 spearcons from the experiment one at a time randomly to the participant. After each spearcon was played, the participants were asked to type in a field what word or phrase they thought the spearcon represented. We also asked six naïve users (new individuals who were not exposed to Experiment 3 in any way) to complete this same follow-up study. The six naïve listeners would presumably allow a determination of which spearcons were more “recognizable” as spoken words. Note that all participants were informed on an introduction screen that spearcons were compressed speech, in order to control for any possible misinterpretation of the origin of the sounds. Na\ddot{v}e participants did not subsequently participate in Experiment 3.

A 2×2 mixed design repeated measures ANOVA was completed on the number of training blocks required for 100% accuracy on the recall test. The first independent variable was a between-subjects measure of cue type (earcons vs. spearcons), and the second independent variable was a within-subjects manipulation of list type (noun list vs. cell phone list). The means and standard deviations of numbers of trial blocks for each of the four conditions are shown in Table 6, and illustrated in the plots 1000 of FIG. 10.

TABLE 6
Number of training blocks needed for
perfect score during Experiment 3.

| Condition | Mean | Std Error (%) |
|---|---|---|
| Spearcon (cell phone list) | 1.08 | 0.28 |
| Spearcon (noun list) | 1.08 | 0.28 |
| Earcon (cell phone list) | 6.55 | 3.30 |
| Earcon (noun list) | 4.55 | 2.25 |

Overall, spearcons led to faster learning than earcons, as supported by the main effect of cue type, F(1, 22)=42.115, p<0.001. This is seen by comparing the average height of the two left bars 1010 in FIG. 10 to the average of the two right bars 1020. It is also relevant to mention that the three individuals who were unable to complete the experiment in the time allowed (two hours), and whose data are not included in the results reported here, were all assigned to the earcons group. This suggests that even larger differences would have been found between earcons and spearcons, if the data for those participants had been included.

Overall, the cell phone list was easier to learn than the noun list, as evidenced by the main effect of list type F(1, 22)=7.086, p=014. These main effects were moderated by a significant interaction of cue type and list type, in which the cell phone list was learned more easily than noun list for the earcon cues (FIG. 10, left pair of bars 1010), but there was no difference in word list learning in the spearcons condition (FIG. 10, right pair of bars 1020), F(1, 22)=7.086, p=0.014.

The spearcon analysis follow-up study data revealed that the training that the participants received on the word/spearcon associations in these lists led to greater comprehension. Out of a possible 60 points, the mean performance of individuals who had completed the spearcons condition in Experiment 3 before the spearcons recall test (M=59.0, SD=1.732) was significantly better than that for the naïve users (M=38.50, SD=3.782), t(9)=11.115, p<0.001). No significant main effect was found for list type in the follow-up study.

Debriefing questions included a six point Likert scale (1=Very Difficult, . . . 6=Very Easy) on which participants were requested to rate the difficulty of the task they had completed. Participants found the earcons task (M=2.91, SD=0.831) significantly more difficult than the same task using spearcons (M=5.25, SD=0.452), t(21)=−8.492, p<001.

As illustrated in FIG. 10 and Table 6, the difference in means between sonification modes was as expected, as spearcons clearly outpaced earcons in learning rates. From a practical standpoint, the support for spearcons as a preferred sonification mode for menu enhancement is fourfold. First, spearcons provide ease of use in any language or application. Second, spearcons do not restrict the structure of a menu system. Their use in a menu hierarchy can be as fluid as necessary because they do not require fixed indications of grid position. This may be true for other menu systems as well. Third, as shown, spearcons are easy to learn, which may reduce learning time for new users. Finally, Spearcons are short in length. With the average size of the earcons used in these experiments over one and a half seconds, and the average spearcons size less than one third of a second, spearcons may provide greater efficiency for users of visual and auditory menus.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A method, comprising:
detecting that a first item in an ordered listing of items is identified; and
providing a first sound associated with the first item for auditory display, the first sound having a pitch corresponding to the location of the first item within the ordered listing of items.

2. The method of claim 1, further comprising:
providing a second sound for auditory display, the second sound having a pitch corresponding to the last location in the ordered listing of items.

3. The method of claim 2, wherein the first sound and the second sound are the same sound, the first sound having a pitch corresponding to the location of the first item within the ordered listing of items and the second sound having a pitch corresponding to the last location in the ordered listing of items.

4. The method of claim 1, further comprising:
providing a second sound for auditory display, the second sound having a pitch corresponding to the first location in the ordered listing of items.

5. The method of claim 1, further comprising:
detecting that a second item in the ordered listing of items is identified; and
providing a second sound associated with the second item for auditory display, the second sound having a pitch corresponding to the location of the second item within the ordered listing of items.

6. The method of claim 5, further comprising:
determining that the location of the second item within the ordered listing of items is between the location of the first item and the last location in the ordered listing of items; and
providing a third sound for auditory display, the third sound having a pitch corresponding to the last location in the ordered listing of items.

7. The method of claim 6, wherein the first sound, the second sound, and the third sound are the same sound, the first sound having a pitch corresponding to the location of the first item within the ordered listing of items, the second sound having a pitch corresponding to the location of the second item within the ordered listing of items, and the third sound having a pitch corresponding to the last location in the ordered listing of items.

8. The method of claim 5, further comprising:
determining that the location of the second item within the ordered listing of items is between the location of the first item and the first location in the ordered listing of items; and
providing a third sound for auditory display, the third sound having a pitch corresponding to the first location in the ordered listing of items.

9. The method of claim 5, further comprising:
determining that the location of the second item within the ordered listing of items is one of the first location and the last location in the ordered listing of items; and
providing the second sound for auditory display a second time.

10. The method of claim 1, wherein the first sound is a beep.

11. The method of claim 1, wherein the first sound is a spearcon corresponding to the first item.

12. The method of claim 1, further comprising:
providing a menu including the ordered listing of items.

13. A telephone, comprising:
a processor circuit having a processor and a memory;
an audio display system stored in the memory and executable by the processor, the audio display system comprising:
logic configured to detect that a first item in an ordered listing of items is identified; and
logic configured to provide a first sound associated with the first item for auditory display through a speaker, the first sound having a pitch corresponding to the location of the first item within the ordered listing of items.

14. The telephone of claim 13, wherein the audio display system further comprises:
logic configured to provide a second sound for auditory display through the speaker, the second sound having a pitch corresponding to the last location in the ordered listing of items.

15. The telephone of claim 14, wherein the first sound and the second sound are the same sound, the first sound having a pitch corresponding to the location of the first item within the ordered listing of items and the second sound having a pitch corresponding to the last location in the ordered listing of items.

16. The telephone of claim 13, wherein the audio display system further comprises:
logic configured to detect that a second item in the ordered listing of items is identified; and
logic configured to provide a second sound associated with the second item for auditory display through the speaker, the second sound having a pitch corresponding to the location of the second item within the ordered listing of items.

17. The telephone of claim 16, wherein the audio display system further comprises:
logic configured to determine that the location of the second item within the ordered listing of items is between the location of the first item and the last location in the ordered listing of items; and
logic configured to provide a third sound for auditory display through the speaker, the third sound having a pitch corresponding to the last location in the ordered listing of items.

18. The telephone of claim 17, wherein the first sound, the second sound, and the third sound are the same sound, the first sound having a pitch corresponding to the location of the first item within the ordered listing of items, the second sound having a pitch corresponding to the location of the second item within the ordered listing of items, and the third sound having a pitch corresponding to the last location in the ordered listing of items.

19. The telephone of claim 16, wherein the audio display system further comprises:
logic configured to determine that the location of the second item within the ordered listing of items is between the location of the first item and the first location in the ordered listing of items; and
logic configured to provide a third sound for auditory display, the third sound having a pitch corresponding to the first location in the ordered listing of items.

20. The telephone of claim 16, wherein the audio display system further comprises:
logic configured to determine that the location of the second item within the ordered listing of items is one of the first location and the last location in the ordered listing of items; and
logic configured to provide the second sound for auditory display a second time.

21. The telephone of claim 13, wherein the first sound is a beep.

22. The telephone of claim 13, wherein the audio display system further comprises:
logic configured to provide a menu including the ordered listing of items.

23. A method, comprising:
detecting that a first item in a listing of items is identified, the first item having associated text;
providing a first spearcon corresponding to the first item for auditory display, the first spearcon based upon the associated text of the first item; and
providing the associated text of the first item for auditory display.

24. The method of claim 23, further comprising:
detecting that a second item in the listing of items is identified, the second item having associated text; and
providing a second spearcon corresponding to the second item for auditory display, the second spearcon based upon the associated text of the second item; and
providing the associated text of the second item for auditory display.

25. The method of claim 23, further comprising:
detecting that a second item in the listing of items is identified before providing the associated text of the first item for auditory display, the second item having associated text; and
providing a second spearcon corresponding to the second item for auditory display without providing the associated text of the first item for auditory display, the second spearcon based upon the associated text of the second item.

26. The method of claim 25, further comprising:
providing the associated text of the second item for auditory display.

27. The method of claim 23, wherein the first spearcon is non-speech.

28. The method of claim 23, further comprising:
providing a menu including the listing of items.

29. A telephone, comprising:
a processor circuit having a processor and a memory;
an audio display system stored in the memory and executable by the processor, the audio display system comprising:
logic configured to detect that a first item in a listing of items is identified, the first item having associated text;
logic configured to provide a first spearcon corresponding to the first item for auditory display through a speaker, the first spearcon based upon the associated text of the first item; and
logic configured to provide the associated text of the first item for auditory display through the speaker.

30. The telephone of claim 29, wherein the audio display system further comprises:
logic configured to detect that a second item in the listing of items is identified, the second item having associated text; and
logic configured to provide a second spearcon corresponding to the second item for auditory display through the speaker, the second spearcon based upon the associated text of the second item; and
logic configured to provide the associated text of the second item for auditory display through the speaker.

31. The telephone of claim 29, wherein the audio display system further comprises:
logic configured to detect that a second item in the listing of items is identified before providing the associated text of the first item for auditory display, the second item having associated text; and
logic configured to provide a second spearcon corresponding to the second item for auditory display through the speaker without providing the associated text of the first item for auditory display through the speaker, the second spearcon based upon the associated text of the second item.

32. The telephone of claim 31, wherein the audio display system further comprises:
logic configured to provide the associated text of the second item for auditory display through the speaker.

33. The telephone of claim 29, wherein the first spearcon is non-speech.

34. The telephone of claim 29, wherein the audio display system further comprises:
logic configured to provide a menu including the listing of items.

35. A method, comprising:
detecting the selection of a first menu; and
providing a first background sound associated with the first menu for auditory display.

36. The method of claim 35, wherein the first background sound corresponds to the depth of the first menu in a hierarchical menu structure.

37. The method of claim 35, further comprising:
detecting the selection of a second menu associated with the first menu; and
providing a second background sound associated with the second menu for auditory display, wherein the second background sound includes the first background sound.

38. The method of claim 37, wherein the first background sound corresponds to the depth of the first menu in a hierarchical menu structure and the second background sound corresponds to the depth of the second menu in the hierarchical menu structure.

39. The method of claim 35, wherein the first background sound is a first spearcon corresponding to a title of the first menu.

40. The method of claim 39, further comprising:
detecting the selection of a second menu associated with the first menu; and
providing a second background sound associated with the second menu for auditory display, wherein the second background sound is a second spearcon corresponding to a title of the second menu, the title of the second menu including the title of the first menu.

41. A system, comprising:
means for detecting the selection of a first menu; and
means for providing a first background sound associated with the first menu for auditory display.

42. The system of claim 41, wherein the first background sound corresponds to the depth of the first menu in a hierarchical menu structure.

43. The system of claim 41, further comprising:
means for detecting the selection of a second menu associated with the first menu; and
means for providing a second background sound associated with the second menu for auditory display, wherein the second background sound includes the first background sound.

44. The method of claim 43, wherein the first background sound corresponds to the depth of the first menu in a hierarchical menu structure and the second background sound corresponds to the depth of the second menu in the hierarchical menu structure.
